(19) United States
(12) Patent Application Publication
(10) Pub. No.: US 2004/0239042 A1
(43) Pub. Date: Dec. 2, 2004

(54) Cylinder head gasket

(76) Inventors: Friedhelm Stecher, Wilhelmshaven (DE); Christoph Stecher, Wilhelmshaven (DE)

Correspondence Address: Edward J. Timmer, Walnut Woods Centre, 5955 West Main street, Kalamazoo, MI, 49009, US

(21) Appl. No.: 10/847,001

(22) Filed: May 17, 2004

(30) Foreign Application Priority Data
May 30, 2003 (DE) 103 24 667.3

(51) Int. Cl. F02F 11/00

(52) U.S. Cl. 277/592

(57) ABSTRACT

Cylinder head gasket which has at least on one side elevations which form gasket sealing surfaces, which surround at least one aperture of the cylinder head gasket in an enclosed manner, for pressing against at least one engine component sealing surface and the height profile of which is designed prior to the installation of the cylinder head gasket to correspond at least approximately to the topography of the sealing gap to be sealed and resulting when a cylinder head gasket is installed, the respective combustion chamber openings of the cylinder head gasket being encircled by these elevations individually, wherein the elevations are formed by at least one basic member provided with a coating, the material of the basic member being selected in such a manner and its cross section being configured in such a manner that the basic member is not deformable in height at least in first sections of the gasket sealing surfaces under the maximum load occurring during the installation of the cylinder head gasket as well as during operation of the engine. In order to improve the sealing properties of such a cylinder head gasket, this is designed such that either at least one basic member is deformable in height in at least one second section of at least one of the gasket sealing surfaces under the maximum load occurring or that at least two gasket sealing surfaces are associated with at least one aperture and surround the latter in an enclosed manner, each of these sealing surfaces having a basic member surrounding this aperture in an enclosed manner, wherein one of these basic members is not deformable in height around the aperture under the maximum load occurring and is provided with the coating forming a sealing surface profiled in height in accordance with the topography of the sealing gap and another one of these basic members is deformable in height around the aperture under the maximum load occurring.

The present disclosure relates to the subject matter disclosed in German application No. 103 24 667.3 of May 30, 2003, which is incorporated herein by reference in its entirety and for all purposes.

### BACKGROUND OF THE INVENTION

The invention relates to a cylinder head gasket with several apertures, which form at least combustion chamber apertures and screw apertures for cylinder head screws, for sealing a sealing gap limited by engine component sealing surfaces of at least one engine block and one cylinder head, wherein the cylinder head gasket has on at least one side elevations which form gasket sealing surfaces surrounding at least one aperture in an enclosed manner for pressing against at least one engine component sealing surface, the height profile of which (i.e., of the gasket sealing surfaces) is designed prior to the installation of the cylinder head gasket to correspond at least approximately to the topography of the sealing gap to be sealed and resulting when a cylinder head gasket is clamped between engine component sealing surfaces, the respective combustion chamber apertures being encircled by the elevations individually, wherein several of the elevations are formed by at least one basic member which is provided with a coating and the material of which is selected in such a manner and the cross section of which is configured in such a manner that the basic member is resistant to pressure and creep and is, therefore, not deformable in height at least in first sections of the gasket sealing surfaces under the maximum load occurring during the installation of the cylinder head gasket as well as during operation of the engine, and wherein the coating is a coating resistant to wear and tear under the loads and relative movements between cylinder head gasket and engine component sealing surfaces occurring during operation of the engine.

A cylinder head gasket of this type results from EP-0 485 693-B1. This cylinder head gasket has an, in particular, one-piece, metallic gasket plate, the shape of which is based on the following consideration: For the functioning of a cylinder head gasket, the engine block (crankcase) and the cylinder head cannot be considered to be absolutely rigid components; on the contrary, the tightening of the cylinder head screws and the varying gas pressures in the combustion chambers lead to vertical flexing of these engine components, i.e., in the long run to the sealing gap, which is limited by the engine component sealing surfaces and accommodates the cylinder head gasket, not retaining the shape of a thin, plane-parallel plate. However, the heat expansions of engine block and cylinder head which vary locally during operation of the engine as well as the locally varying component rigidity of these two engine components in areas bordering on their sealing surfaces also have an influence on the topography of the engine component sealing surfaces limiting the sealing gap during operation of the engine. The shaping of the gasket plate of the cylinder head gasket in accordance with EP-0 485 693-B1 is based on the fundamental idea of adapting the shape of the gasket plate in the areas effective for the sealing to the topography of the engine component sealing surfaces, as present following the tightening of the cylinder head screws, i.e., after the installation of the cylinder head gasket, and of not allowing the elastic component deformations required for maintaining the sealing during operation of the engine to occur at or in the cylinder head gasket but rather, on the contrary, at or in the engine components engine block and cylinder head so that the gasket plate may be produced from a material which is stable, i.e., not deformable in its thickness during tightening of the cylinder head screws and during operation of the engine. This fundamental idea for the design of a cylinder head gasket does not, of course, preclude the gasket plate being provided with a plastic coating which serves the purpose of the so-called microsealing and can be adapted to surface roughnesses of the engine component sealing surfaces.

The preceding explanations concerning the cylinder head gasket according to EP-0 485 693-B1 result in the fact that its basic principle is in contrast to the functioning of the conventional (single or multiple layered) metallic cylinder head gaskets which are provided, in the areas to be sealed, with beads which can be deformed in height in a spring elastic manner.

There are cases where cylinder head gaskets are used, in which a cylinder head gasket of the type mentioned at the outset and having a gasket plate which is to be considered as rigid does not lead to optimum results: In the case of a reciprocating combustion engine with a so-called chain case, the latter is often formed by a lower part of the chain case bordering on the engine block and an upper part of the chain case bordering on the cylinder head, wherein one of the two parts may also be integrally formed on the adjacent component engine block or cylinder head; the sealing gap is then limited by the engine block, the cylinder head and at least one part of the chain case. If the cavity in the chain case is also intended to be sealed as a whole or partially by the cylinder head gasket, this also extends over at least one area of the part of the chain case produced as a separate component. However, production tolerances often result in the sealing surface, which faces the cylinder head gasket, of the part of the chain case produced as a separate component not being in exact alignment with the bordering sealing surface of the engine block and the cylinder head, respectively, after its assembly and so the sealing gap to be sealed by the cylinder head gasket has a step-like widening or narrowing at the joint area of chain case part and engine block or cylinder head, respectively, and is very difficult to seal with a cylinder head gasket having a rigid gasket plate—if, for example, production tolerances lead to the sealing gap being narrower in the area of the chain case than between engine block and cylinder head, a cylinder head gasket with a rigid gasket plate can result in the specific surface pressures between the cylinder head gasket and the engine block, on the one hand, as well as the cylinder head, on the other hand, not being adequate in the sealing gap area located between engine block and cylinder head for a reliable sealing under all operating conditions, at least in certain areas. When a cylinder head gasket of the type mentioned at the outset has several apertures which lie relatively close to one another and are intended to be sealed relative to one another and relative to the surroundings by several gasket sealing surfaces which are approximately strip-like or linear and abut on one another or merge into one another, the system consisting of cylinder head gasket and engine component sealing surfaces can, in certain circumstances, be overdetermined statically in such an area and lead to a faulty seal. In addition, permanent deformations of the engine block sealing surface may occur in those areas of the engine block, in which the cylinder head screws engage, which can likewise result in problems, in particular, during the replacement of the cylinder head gasket when using a replacement gasket having a rigid gasket plate.

The object underlying the invention was, therefore, to provide an improved cylinder head gasket of the type mentioned at the outset, with which the problems discussed may be eliminated or at least reduced.

### SUMMARY OF THE INVENTION

For this purpose, a cylinder head gasket of this type is designed in accordance with the invention such that the or at least one basic member is deformable in height in at least one second section of at least one of the gasket sealing surfaces, which have, in particular, an approximately strip-like or linear form, under the maximum load occurring during the installation of the cylinder head gasket and/or during operation of the engine, either because the basic member is dimensioned differently and/or is of a different design in cross section in such a second section than in a first section which is not deformable in height or because the basic member has different material properties in such a second section than in a first section which is not deformable in height.

An alternative, inventive solution is defined by the attached claim 2.

An inventive cylinder head gasket therefore combines the fundamental idea of the cylinder head gasket known from EP-0 485 693-B1 and its advantages with a feature which results in the inventive cylinder head gasket being adaptable in selected areas to changes in the topography of the engine component sealing surfaces which may result during tightening of the cylinder head screws, i.e., during the assembly of the cylinder head gasket and/or during the first warm-up phase of the engine but, where applicable, also in an initial operating period of the engine; furthermore, an inventive cylinder head gasket is, where applicable, in a position to compensate for production tolerances and to be adaptable to permanent changes to the engine component sealing surfaces resulting during operation of the engine, in particular, during the installation of a replacement gasket.

In conjunction with the definition specified at the outset of the type of cylinder head gaskets, to which the present invention relates, the following should be pointed out: Instead of a single cylinder head, one cylinder head could also be provided for each of the individual cylinders, as is often the case for commercial vehicles. The engine component sealing surfaces mentioned can be formed not only by the engine block and at least one cylinder head but also, for example, by a part of a chain case or parts of several chain cases. The specified elevations will advantageously be provided not only on one side of the cylinder head gasket but rather on both sides of the gasket so that the thickness profile of the cylinder head gasket is configured in accordance with the topography of the sealing gap at least in sections. The type of gasket covered by the invention can have a gasket plate in the conventional sense but it is just as possible to provide several gasket segments, on which the elevations forming the gasket sealing surfaces are provided, and to connect the sealing segments to one another via connecting webs or the like so that a skeleton-like construction results. When it is said that the inventive cylinder head gasket has elevations which form strip-like or linear gasket sealing surfaces, it results from this wording that not all the elevations formed on the gasket have to form such strip-like or linear gasket sealing surfaces. The gasket sealing surfaces may—in a plan view—also have a profile in their width. An inventive cylinder head gasket may have one or several of the basic members mentioned which can be separate from one another or connected to one another in one piece, as is, for example, the case when a metallic gasket plate forms web-like elevations, which represent basic members of this type, following a stamping procedure. If an inventive cylinder head gasket has several basic members, only a single basic member could be configured in accordance with the invention, even if, for example, all the basic members are parts of a single gasket plate.

It should also be mentioned that an inventive cylinder head gasket should, of course, not “age”, i.e., the second section or the second sections of the at least one basic member should be deformable in height (plastically and/or elastically) under a certain, relatively high load, namely preferably deformable plastically, where applicable also only predominantly plastically but be designed such that such a second section of a basic member is stable following a certain height deformation and the reduction in the load related thereto, i.e., is not deformable in height to any further degree under the reduced load. The same applies for the basic member which is deformable in height in accordance with claim 2 but which can also be deformable in height only elastically; moreover, this basic member can also be provided with the coating mentioned and/or with the cover layer still to be mentioned.

In accordance with the last paragraph of the description and claim 5 of EP-0 485 693-B1 (cf. also WO 01/16240-A1), it may be recommendable to configure an inventive cylinder head gasket such that the coating is provided at the elevations, at least in sections, with a cover layer deformable in the microrange so that a reliable seal can also be provided at engine component sealing surfaces having a certain surface roughness, wherein the thickness of this deformable cover layer is intended to be only a fraction of the thickness of the layer of the coating of the basic member. Without a cover layer, the coating of the basic member therefore forms the relevant gasket sealing surface; otherwise, the latter is formed by the cover layer.

Although, as results from EP-0 485 693-B1, other solid materials can also be used, the material of the basic member is preferably a metallic material.

A plastic coating is recommended as coating for the basic member although, in principle, a metallic or metal-like coating would also be conceivable. The same applies for the cover layer serving the purpose of microsealing.

The coating of the basic member serves, above all, the purpose, in particular, in the case of a metallic basic member of avoiding any direct contact of the latter with one of the engine component sealing surfaces which are likewise metallic. On the other hand, the coating of the basic member is intended to be resistant to wear and tear during operation of the engine, for which reason it is recommended to select such a material for this coating that the coating is at least essentially and, preferably, actually resistant to pressure and creep under the maximum load occurring during the installation of the cylinder head gasket as well as during operation of the engine in order to prevent the actual basic member being able to come into direct contact with one of the engine component sealing surfaces during the course of operation of the engine.

During operation of the engine, sliding movements between the cylinder head gasket and engine component sealing surface occur almost unavoidably and these can lead to appearances of wear and tear on the gasket and/or on the engine component sealing surface. For this reason, the coating of the basic member in preferred embodiments of the inventive cylinder head gasket consists of such a material that the sliding friction between the coating of the basic member and the engine component sealing surfaces is less in the case of the sliding movements mentioned than in the case of a direct contact of the basic member with the engine component sealing surfaces.

Suitable coating materials for achieving the pressure resistance and the reduction in the sliding friction can be found in WO 01/16240-A1.

As a result of the coating of the basic member and the cover layer serving the purpose of microsealing, a decrease in hardness towards the surface of the elevations results in preferred embodiments of the inventive cylinder head gasket and so the cylinder head gasket has on the surface of the elevations with the coating a hardness which is less than the hardness of the coating on its side facing the basic member. Coatings with this property may likewise be found in WO 01/16240-A1.

As results from the preceding explanations concerning the problems to be minimized by the invention, the basic member is deformable in height, preferably plastically, in the vicinity of at least one screw aperture in advantageous embodiments of the inventive cylinder head gasket.

It also results from these comments that in the case of a cylinder head gasket with a recess associated with a chain case and a gasket sealing surface extending in the vicinity of the edge of the recess the basic member associated with this gasket sealing surface is advantageously deformable in height, at least in sections.

The height profile of the gasket sealing surfaces which are preferably approximately strip-like or linear can be formed on the basic member so that the basic member has a height profile corresponding to the height profile of the gasket sealing surface borne by it and the coating or the coatings are of a uniform layer thickness; it is, however, also possible to produce at least one part of the height profile by means of a coating with a varying layer thickness, wherein embodiments are recommended, with which the coating has a layer thickness varying in accordance with the height profile of the gasket sealing surface so that not only the basic member but also the coating need not be profiled as to their height. Coatings with a varying layer thickness are known per se from gasket technology and may be produced, for example, by means of processes similar to screen printing.

Finally, it should also be pointed out that the crest of a basic member or section of a basic member deformable in height may be at a different level with respect to height than the crest of an adjacent basic member or section of a basic member which is not deformable in height, e.g., when during the course of the installation of the gasket the basic member or section of the basic member deformable in height is intended to be effective first of all and to be deformed prior to the required sealing surface pressure being brought about at the basic member or section of the basic member which is not deformable in height. The thickness of the cylinder head gasket can then be selected to be somewhat larger in the area of the crest of a basic member or section of a basic member which is deformable in height than the expected height of the sealing gap at this point.

Additional features, advantages and details of the invention result from the attached drawings as well as the following description.

### BRIEF DESCRIPTION OF THE DRAWINGS

FIG. 1A shows a plan view of a cylinder head gasket for a reciprocating combustion engine with a chain case for illustrating the conceivable gasket sealing surface areas which can be deformed in height in accordance with the invention;

FIG. 1B shows an illustration of an inventive cylinder head gasket corresponding to FIG. 1A;

FIGS. 2A to 2F show a section according to line 2-2 in FIG. 1 but for six different embodiments;

FIG. 2G shows a section according to line 2′-2′ in FIG. 1;

FIGS. 3A to 3C show sections through a basic member surrounding the combustion chamber apertures of the cylinder head gasket shown in FIG. 1 like a frame in the area “A” marked by a dashed line in FIG. 1, wherein these are sections through areas of the basic member following one another in a longitudinal direction of the basic member at a transition from a section of the basic member not deformable in height into a section of the basic member deformable in height;

FIGS. 4A to 4C and

FIGS. 5A to 5C show illustrations corresponding to FIGS. 3A to 3C for two additional embodiments of a basic member at such a transition, and

FIG. 6 shows a section through a part of an additional embodiment bordering on an aperture to be sealed.

### DETAILED DESCRIPTION OF THE INVENTION

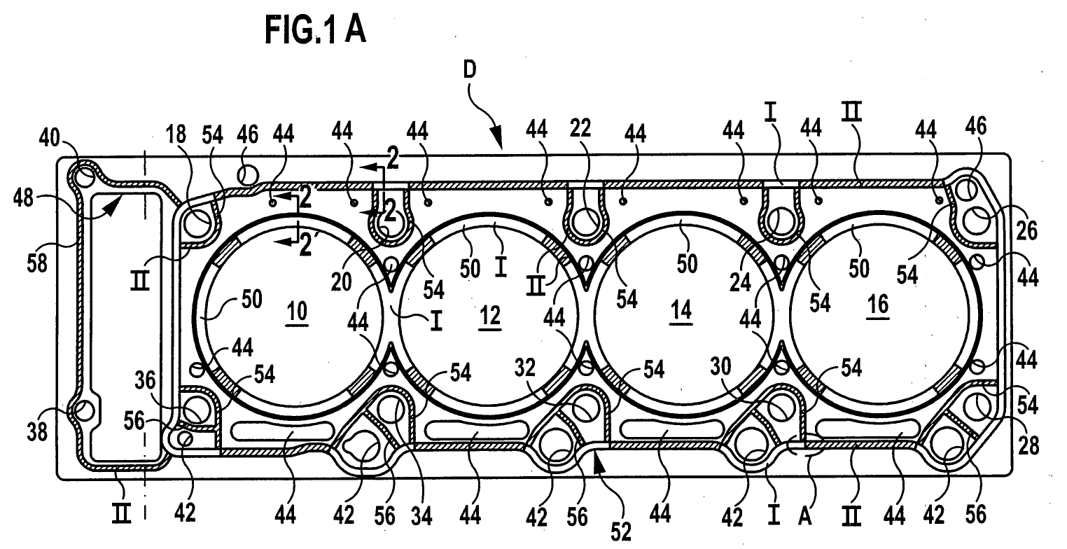

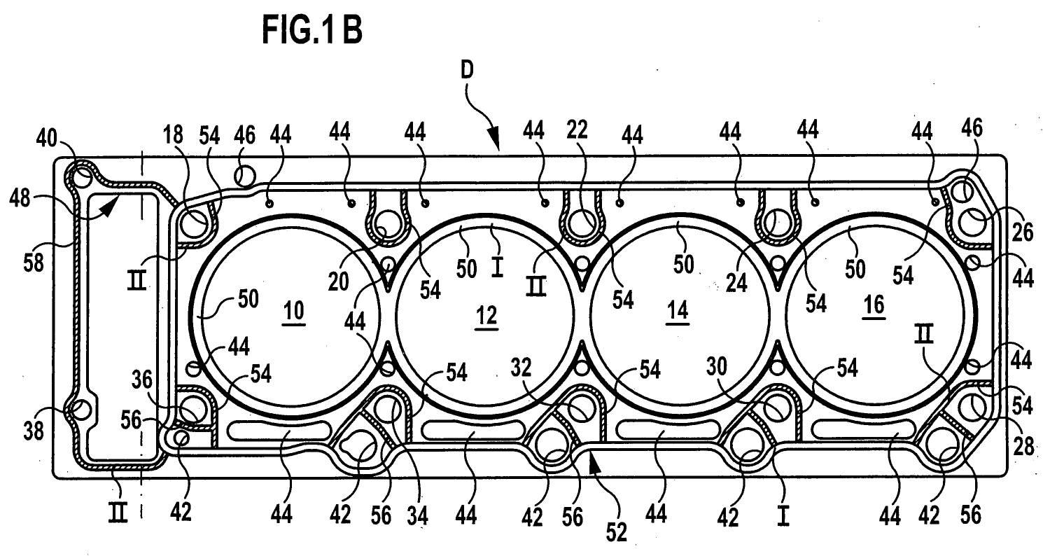

The cylinder head gasket illustrated in a plan view in FIG. 1A is intended to be a gasket of the type which is formed at least essentially by a metallic, at least partially coated gasket plate D which has, following a stamping procedure, basic members designed in accordance with the invention and from which a plurality of apertures have been punched, namely four combustion chamber apertures 10, 12, 14, 16, screw holes 18 to 36 for the passage of cylinder head screws, screw holes 38 and 40 for the passage of screws serving for the assembly of a part of a chain case, oil apertures 42, water apertures 44 and positioning holes 46 for the passage of, for example, positioning pins secured in the engine block. Furthermore, a chain case aperture 48 is also provided in this cylinder head gasket.

Each of the combustion chamber apertures 10 to 16 is encircled by a basic member 50 which is of a circular form in the plan view and has the shape of a circular web projecting towards the person looking at FIG. 1A, at least on the side of the cylinder head gasket visible in FIG. 1A; on the opposite side of the cylinder head gasket which is not visible in FIG. 1A, the basic member can have, for example, two webs forming circles concentric to one another. With respect to the shape of this and all other basic members, reference is made to the additional Figures in the drawings. The basic members 50 and all additional basic members still to be described in the following are intended to be in one piece with the metallic gasket plate D in the embodiment illustrated and have been formed from this by way of stamping. As is apparent in FIG. 1A, the four basic members 50 of this embodiment merge into one another in accordance with the invention in the web-like areas of the gasket plate D located between the combustion chamber apertures 10 to 16.

A second basic member 52, for which the same should preferably apply with respect to its cross-sectional shape and production as for the basic member 50, encloses all the combustion chamber apertures 10 to 16, the screw holes 18 to 36, all oil and water holes 42 and 44, respectively, as well as the one positioning hole 46 in the approximate form of a frame.

A number of additional basic members are formed on the gasket plate D and these do not form complete, continuous lines in the illustrated embodiment in contrast to the basic member 52 but rather end at the basic member 52 or at another one of the additional basic members but merge seamlessly into the latter. In the case of preferred embodiments, each of these additional basic members does, however, form a complete, continuous line together with the basic member 52 or together with another one of the additional basic members (of course, in a plan view of the cylinder head gasket). These additional basic members are the following:

First additional basic members 54 each surround a screw hole 34 together with the frame-like basic member 52, wherein several of these basic members 54—together with the basic member 52—also surround an additional aperture, namely either an oil hole 42 or the one positioning hole 46. Insofar as one of these first additional basic members 54 serves not only for sealing around a screw hole 34 but also for sealing around an oil hole 42, a second, respective additional basic member 56 is provided which ends, on the one hand, at the basic member 52 and, on the other hand, at the adjacent basic member 54 and thus seals the relevant oil hole in relation to the adjacent screw hole.

A third, additional basic member 58 surrounds the chain case aperture 48 on three sides and also encompasses the two screw holes 38 and 40; this third additional basic member 58 ends at the frame-shaped basic member 52 in order to be able to seal the chain case aperture 48 all around.

In FIG. 1A, sections of the various basic members which are not deformable in height have been designated as I whereas second sections of the basic members which are deformable in height in accordance with the invention have, in contrast to the sections I, been hatched and designated as II. It is also apparent from FIG. 1A in this connection that the additional basic members 54, 56 and 58 mentioned above are intended to be, altogether, deformable in height, wherein it should be mentioned with a view to the general definition of the present invention (claim 1) that all these additional basic members can also be considered to be parts of the basic member 52 since they merge into the basic member 52.

FIG. 1A is not intended to illustrate an inventive gasket which can be used in practice but rather it serves only the purpose of specifying, in the case of the type of gasket illustrated, all those areas of the basic member which could be designed to be deformable in height, even if not in the combination shown.

When looking at FIG. 1A, several principles of preferred embodiments of the present invention can also be recognized:

At least two sections of basic members which are not deformable in height are provided for each combustion chamber aperture and these are preferably located approximately diametrically opposite one another.

In the peripheral areas of the cylinder head gasket, at least one section of a basic member not deformable in height is provided in the vicinity of each combustion chamber aperture; the cylinder head gasket does, however, preferably have in its peripheral areas in the vicinity of each combustion chamber aperture at least two sections of basic members which are not deformable in height and are arranged so as to be adjacent to the two longitudinal sides of the gasket plate.

Finally, a design of the cylinder head gasket is preferred such that the screw holes adjacent to the combustion chamber apertures are surrounded by basic members or sections of basic members which are deformable in height at least over a predominant portion of their length.

In the case of an installed cylinder head gasket, a chain case part produced as a separate component is located above and/or below those peripheral areas of the cylinder head gasket which are adjacent to the chain case aperture 48 on the narrow side and on the two longitudinal sides of the cylinder head gasket and the course of the junction area between this part of the chain case and the engine block or the cylinder head has been indicated in FIG. 1A by a dash-dot line. It may be expedient to provide small holes in the gasket plate in the extension of the basic member 58 above or below this junction area and to insert a respective elastomeric sealing element into them in order to provide an even better seal in the area of this junction.

FIG. 1B illustrates an actual embodiment of an inventive cylinder head gasket with a chain case aperture; FIG. 1B differs from FIG. 1A only in that the gasket illustrated in FIG. 1B has fewer sections of basic members which are deformable in height in accordance with the invention, for which reason the same reference numerals have been used in FIG. 1B as in FIG. 1A and FIG. 1B does not, otherwise, require any further explanation.

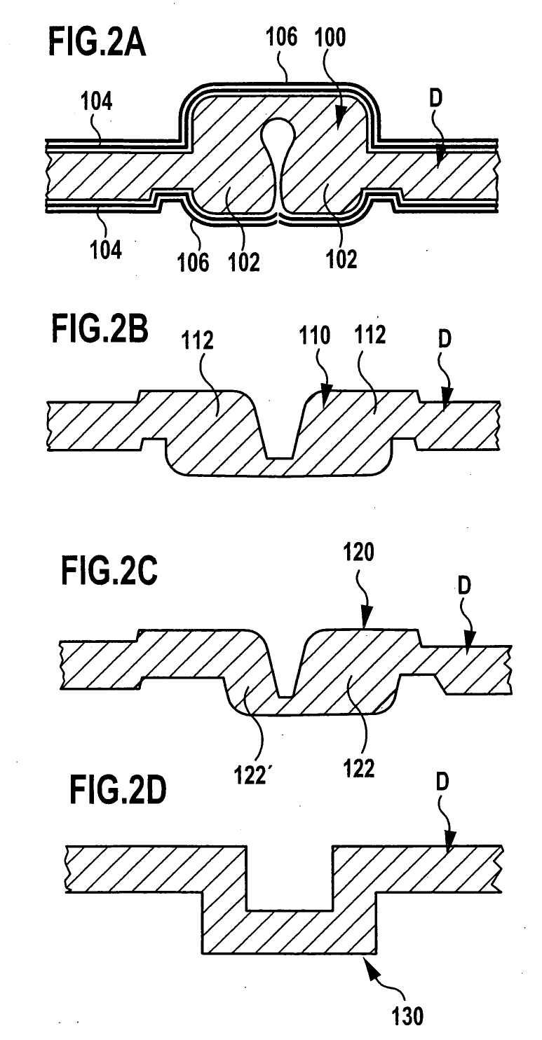

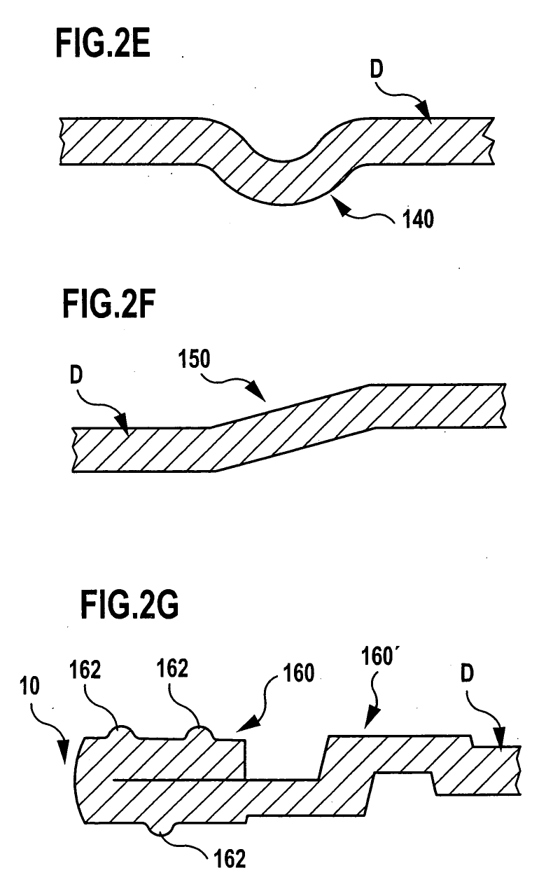

FIG. 2A shows an area of the metallic gasket plate D from FIG. 1A or FIG. 1B, a part of which has been reshaped to form a basic member designated as a whole as 100. The basic member 100 has an approximately omega-shaped cross section with two supporting webs 102 which are rigid under pressure, i.e., not deformable in height during the installation of the gasket and during operation of the engine and forms an elevation on either side of the gasket plate D, wherein the elevation is divided in longitudinal direction of the basic member on the one side of the gasket plate as a result of the omega-shaped cross section. So that the basic member 100 is not deformable in height in practice, the wall thicknesses of the supporting webs 102, i.e., the width of the supporting webs measured horizontally in accordance with FIG. 2A must, of course, be sufficiently great.

The coating 104 provided in accordance with the invention and the cover layer 106 present in preferred embodiments of the invention have also been indicated in FIG. 2A; the coating can extend over the entire two main surfaces of the cylinder head gasket but also only over the elevations formed by the basic member 100 on both sides of the gasket plate D, and the same applies for the cover layer 106.

In all the additional Figures of the drawings, the coating provided in accordance with the invention and the cover layer present in preferred embodiments have been omitted for the sake of simplicity.

FIG. 2B again shows an area of the gasket plate D, a part of which has been reshaped to form a basic member designated as a whole as 110. The basic member 110 has an approximately V-shaped cross section and likewise forms two supporting webs 112 which are not deformable in height on account of their dimensioning.

FIG. 2C shows an area of the gasket plate D, a part of which has been reshaped to form a basic member which is designated as a whole as 120 and has an asymmetric cross section with a supporting web 122 which is not deformable in height as well as a supporting web 122′ which has weaker dimensions and is, therefore, deformable in height. The supporting web 122 can form strip-like gasket sealing surfaces which are not deformable in height on both sides of the gasket under the conditions of use of the cylinder head gasket, the supporting web 122′, however, forms strip-like gasket sealing surfaces which are deformable in height.

FIGS. 2D to 2F show additional possible embodiments of basic members in cross section and do not require any more detailed explanation. In FIGS. 2D to 2F, the basic members have been designated as a whole as 130, 140 and 150, respectively. The basic member 130 is a so-called rectangular bead, the basic member 140 is a full bead designed as usual in cross section so as to be approximately arc-shaped and the basic member 150 is a so-called semi-bead, the cross section of which corresponds approximately to a flattened Z.

The section shown in FIG. 2G through a basic member surrounding a combustion chamber aperture (in particular, the combustion chamber aperture 10) makes it apparent that the area of the gasket plate D shown in FIG. 2G has been folded back upon itself around the combustion chamber aperture 10 in order to produce a basic member designated as a whole as 160 in this way. Prior to the folding or beading of the edge area of the gasket plate D which later surrounds the combustion chamber aperture 10, this has, however, been subjected to a stamping procedure in order to produce the cross-sectional profile illustrated in FIG. 2G, namely including inventive linear ribs 162 of extremely small dimensions which extend in longitudinal direction of the basic member and surround the aperture to be sealed in a complete, annular form. Typical dimensions for such ribs of a metallic basic member are a width of approximately 0.3 to approximately 0.4 mm and a height of approximately 10 μm. Such ribs serve to increase the specific surface pressure between cylinder head gasket and adjacent engine component sealing surface or adjacent engine component sealing surfaces, and it also goes without saying that only a single such rib may be provided on each side of a basic member, where applicable only a single such rib on only a single side of the basic member. The coating 104 shown in FIG. 2A and the cover layer 106 likewise shown therein may be produced on the basic member such that when looking at the finished cylinder head gasket the rib or the ribs are no longer visible—in this case, the layer thickness of the coating and/or the cover layer is, of course, not constant overall.

As illustrated in FIG. 2G, a basic member 160′ can extend adjacent to the basic member 160 and this likewise surrounds the aperture 10; the basic member 160 could in this case not be deformable in height around the aperture 10 but be provided with a height profile whereas the basic member 160′ could be deformable in height around the aperture and have no height profile.

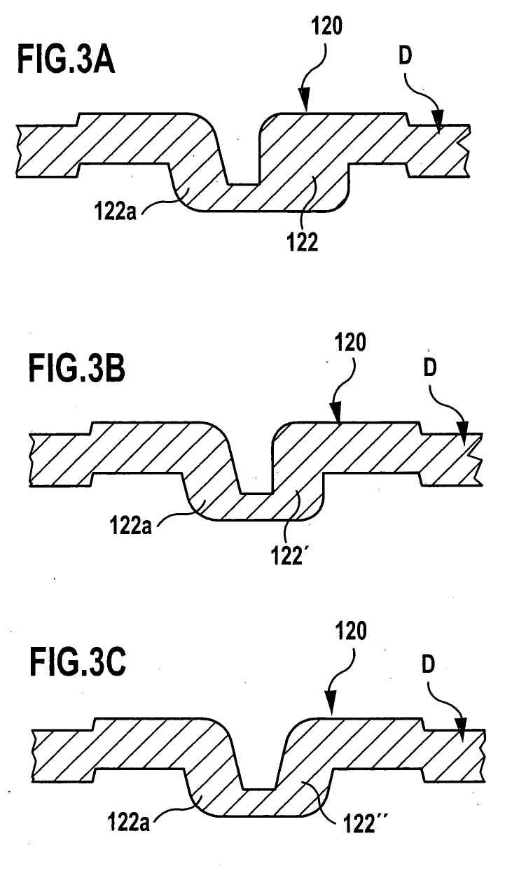

FIGS. 3A to 3C are intended to illustrate the transition from a first section of a basic member which is not deformable in height into a second section of such a basic member which is deformable in height in accordance with the invention, namely on the basis of the basic member 120 illustrated in FIG. 2C. FIG. 3A shows a cross section through a first section of the basic member 120, which is not deformable in height, with the supporting web 122 which is rigid against deformation and has a relatively large width and a supporting web 122a which is placed at a slight angle and has a smaller wall thickness. FIG. 3B shows a cross section through an area of the basic member 120 which is adjacent to the area illustrated in cross section in FIG. 3A. In the area illustrated in FIG. 3B, the wall thickness of the supporting web to the right in the drawing is already clearly smaller than in FIG. 3A, for which reason this right-hand supporting web has been designated in FIG. 3B as 122′. The right-hand supporting web 122 and 122′, respectively, is, however, still approximately at right angles to the plane defined by the gasket plate D not only in FIG. 3A but also in FIG. 3B. Finally, FIG. 3C shows a section through the basic member 120 in an area which is adjacent to the area illustrated in FIG. 3B, wherein the three areas illustrated in FIGS. 3A, 3B and 3C follow one another in this sequence (in longitudinal direction of the basic member 120). In FIG. 3C, the right-hand supporting web designated as 122″ has the same wall thickness as the right-hand supporting web 122′ shown in FIG. 3B but the right-hand supporting web 122″ extends in FIG. 3C at a slight angle, as a result of which the deformability in height of the basic member 120 is increased. In all three areas illustrated in FIGS. 3A, 3B and 3C, the left-hand supporting web 122a has the same dimensions and the same orientation since the rigidity against deformation of the area illustrated in FIG. 3A is based on the wall thickness and orientation of the right-hand supporting web 122.

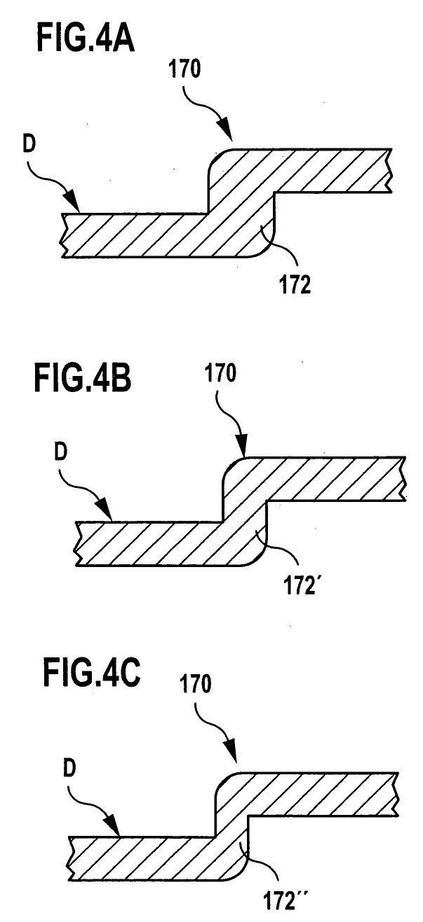

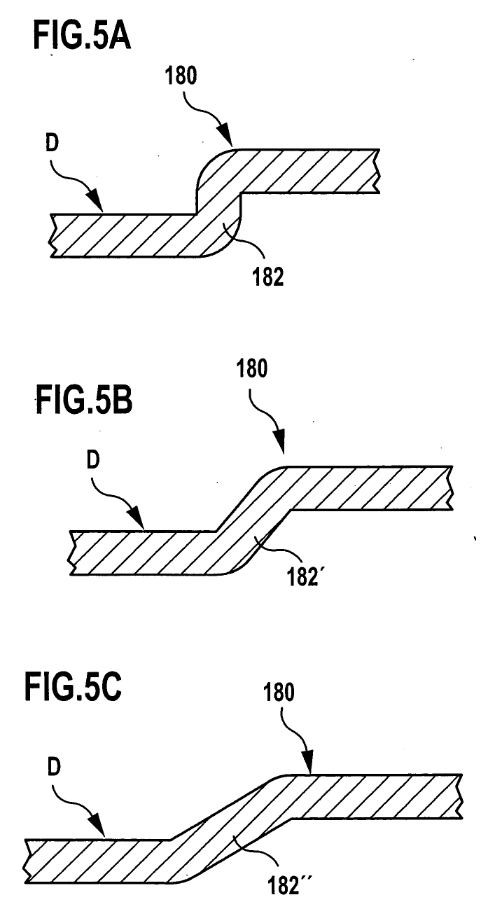

FIGS. 4A to 4C as well as FIGS. 5A to 5C show two additional embodiments of a basic member in the same sequence as FIGS. 3A to 3C, namely the transition of the respective basic member from a section not deformable in height into a section deformable in height in accordance with the invention. In both embodiments the basic member has the form of a so-called semi-bead.

In the area of a basic member 170 illustrated in FIG. 4A, this is not yet deformable in height and has a vertical supporting web 172 of a relatively large width or rather wall thickness; the latter is, in particular, reduced continuously during the transition from a first section not deformable in height into a second section of the basic member 170 deformable in height, as is apparent from the supporting webs 172′ and 172″ in FIGS. 4B and 4C. The orientation of the supporting web remains unchanged in the embodiment illustrated.

In FIGS. 5A to 5C, a basic member 180 is illustrated, with which the wall thickness of a supporting web 182, 182′ and 182″, respectively, remains unchanged along the transition from a section of the basic member not deformable in height into a section of the basic member deformable in height; on the other hand, a transition takes place from a vertical supporting web 182 into a supporting web 182′ and 182″, respectively, which is inclined more and more and so the basic member 180 may be deformed in height, i.e., flattened under the loads applied during the installation of the cylinder head gasket in that section or in those sections, in which the basic member has the cross section illustrated in FIG. 5C.

For example, the cross section illustrated in FIG. 2C could also be interpreted such that it forms a first basic member in the form of the supporting web 122 and a second basic member in the form of the supporting web 122′ which could be configured in accordance with claim 2, namely with a basic member in the form of the supporting web 122 which is not deformable in height around an aperture to be sealed but is provided with a height profile and a basic member in the form of the supporting web 122′ which is deformable in height around the aperture to be sealed but has no height profile.

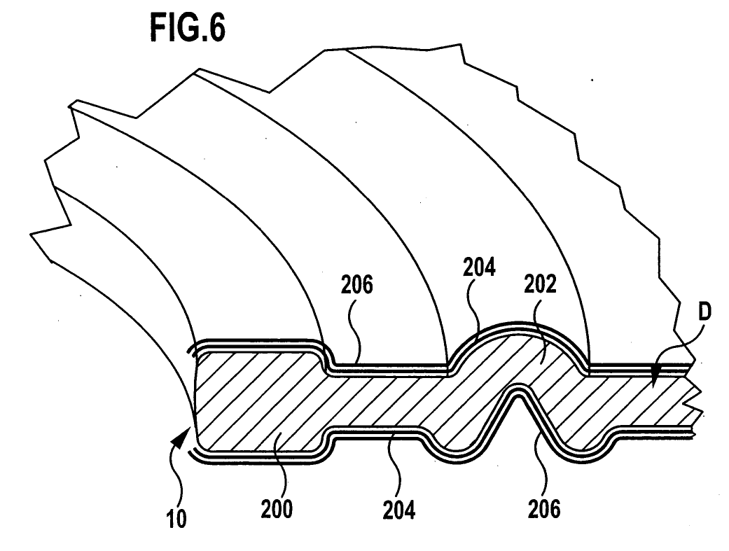

In FIG. 6, a section through an additional embodiment is illustrated which could be a section along the line 2′-2′ in FIG. 1A so that the combustion chamber aperture 10 would be located to the left of the part of a gasket plate D illustrated in FIG. 6. A first basic member 200 borders directly on this and this basic member is intended not to be deformable in height around the combustion chamber aperture 10 but be provided with a height profile corresponding to the topography of the sealing gap. A second basic member 202, which has the shape of a conventional full bead and is intended to be deformable in height around the combustion chamber aperture 10 but has no height profile, is formed on the gasket plate D radially outside the first basic member 200 with respect to the combustion chamber aperture 10. As in FIG. 2A, an inventive coating 204 as well as an inventive cover layer 206 have been illustrated in FIG. 6 and these are provided on both sides of the gasket not only on the basic member 200 but also on the basic member 202. The embodiment illustrated in FIG. 6 could, however, also be modified such that the basic member 202 has no coating whatsoever or only the cover layer 206 serving the purpose of microsealing. The embodiment illustrated in FIG. 6 therefore accomplishes the inventive solution according to claim 2.

It should also be noted with respect to FIG. 1A that the basic member 58 need not necessarily be deformable in height in the vicinity of the adjacent narrow side of the gasket plate D because the areas of the adjacent engine components located there above or below the cylinder head gasket are, where applicable, subjected to a bending deformation, which is sufficient for solving the problems, by means of the screws extending through the screw holes 38 and 40.

When assessing the invention, it must be kept in mind that each cylinder head gasket is constructed for a quite specific engine, i.e., the gasket engineer is aware of the changes in shape of the engine components occurring during the assembly of the cylinder head gasket and during operation of the engine as well as the tightening torques of the screws serving to clamp the gasket in place predetermined by the manufacturer of the engine. This makes it possible to determine the topography of the sealing gap resulting when a cylinder head gasket is installed by means of a finite-element method calculation and to configure and dimension the cylinder head gasket accordingly. Alternatively, the method described in EP-0 485 693-B1 could be used for this purpose, according to which a pattern plate is clamped between the engine components and is plastically deformed accordingly in order to model the topography of the sealing gap and then configure the gasket.

The present invention has been described and claimed with reference to a cylinder head gasket. The inventive forms and dimensions may, however, also be used for other flat gaskets, in particular, for other flat gaskets used in conjunction with combustion engines, wherein the following uses are of particular importance: an exhaust manifold gasket for sealing between an exhaust manifold and a cylinder head, flange gaskets for installation in an exhaust train, so-called cylinder base gaskets which are used, in particular, in flat engines at the transition between a cylinder block and a crankcase as well as flat gaskets for sealing at cylinder liners either under a liner flange and/or at the lower end of a cylinder liner facing away from the cylinder head.

1. Cylinder head gasket with several apertures, said apertures forming at least combustion chamber apertures and screw apertures for cylinder head screws, for sealing a sealing gap limited by engine component sealing surfaces of at least one engine block and one cylinder head, wherein the cylinder head gasket has on at least one side elevations forming gasket sealing surfaces surrounding at least one aperture in an enclosed manner for pressing against at least one engine component sealing surface, the height profile of said elevations being designed prior to the installation of the cylinder head gasket to correspond at least approximately to the topography of the sealing gap to be sealed and resulting when the cylinder head gasket is clamped between engine component sealing surfaces, and the respective combustion chamber apertures being encircled by said elevations individually, wherein the elevations are formed by at least one basic member provided with a coating, the material of said basic member being selected in such a manner and its cross section being configured in such a manner that the basic member is resistant to pressure and creep and is, therefore, not deformable in height at least in first sections of the gasket sealing surfaces under the maximum load occurring during the installation of the cylinder head gasket as well as during operation of the engine, and wherein the coating is a coating resistant to wear and tear under the loads and relative movements between cylinder head gasket and engine component sealing surfaces occurring during operation of the engine, wherein at least one basic member is deformable in height in at least one second section of at least one of the gasket sealing surfaces under the maximum load occurring during the installation of the cylinder head gasket and/or during operation of the engine.

2. Cylinder head gasket with several apertures, said apertures forming at least combustion chamber apertures and screw apertures for cylinder head screws, for sealing a sealing gap limited by engine component sealing surfaces of at least one engine block and one cylinder head, wherein the cylinder head gasket has on at least one side elevations forming gasket sealing surfaces surrounding at least one aperture in an enclosed manner for pressing against at least one engine component sealing surface, the height profile of said elevations being designed prior to the installation of the cylinder head gasket to correspond at least approximately to the topography of the sealing gap to be sealed and resulting when the cylinder head gasket is clamped between engine component sealing surfaces, and the respective combustion chamber apertures being encircled by said elevations individually, wherein the elevations are formed by at least one basic member provided with a coating, the material of said basic member being selected in such a manner and its cross section being configured in such a manner that the basic member is resistant to pressure and creep and is, therefore, not deformable in height at least in first sections of the gasket sealing surfaces under the maximum load occurring during the installation of the cylinder head gasket as well as during operation of the engine, and wherein the coating is a coating resistant to wear and tear under the loads and relative movements between cylinder head gasket and engine component sealing surfaces occurring during operation of the engine, wherein at least two gasket sealing surfaces are associated with at least one aperture and surround the latter in an enclosed manner, each of said at least two sealing surfaces having a basic member surrounding said aperture in an enclosed manner, wherein
(a) one of said basic members is resistant to pressure and creep and is, therefore, not deformable in height around said aperture under the maximum load occurring during the installation of the cylinder head gasket as well as during operation of the engine and is provided with said coating forming a sealing surface which is profiled in height in accordance with the topography of the sealing gap, and
(b) another one of said basic members is deformable in height around said aperture under the maximum load occurring during the installation of the cylinder head gasket as well as during operation of the engine.

3. Cylinder head gasket as defined in claim 1, wherein the coating is provided at least in sections with a cover layer deformable in the range of one or several micrometers.

4. Cylinder head gasket as defined in claim 2, wherein the coating is provided at least in sections with a cover layer deformable in the range of one or several micrometers.

5. Cylinder head gasket as defined in claim 1, wherein the material of the basic member is a metallic material.

6. Cylinder head gasket as defined in claim 2, wherein the material of the basic member is a metallic material.

7. Cylinder head gasket as defined in claim 1, wherein the coating is a plastic coating.

8. Cylinder head gasket as defined in claim 2, wherein the coating is a plastic coating.

9. Cylinder head gasket as defined in claim 3, wherein the cover layer is a plastic cover layer.

10. Cylinder head gasket as defined in claim 4, wherein the cover layer is a plastic cover layer.

11. Cylinder head gasket as defined in claim 1, wherein the coating consists of such a material that the coating is at least essentially resistant to pressure and creep under the maximum load occurring during the installation of the cylinder head gasket as well as during operation of the engine.

12. Cylinder head gasket as defined in claim 2, wherein the coating consists of such a material that the coating is at least essentially resistant to pressure and creep under the maximum load occurring during the installation of the cylinder head gasket as well as during operation of the engine.

13. Cylinder head gasket as defined in claim 1, wherein the coating consists of such material that, in the case of the sliding movements between cylinder head gasket and engine component sealing surfaces occurring during operation of the engine, the sliding friction between the gasket sealing surfaces and the engine component sealing surfaces is less than the sliding friction when the basic member would be in direct contact with the engine component sealing surfaces.

14. Cylinder head gasket as defined in claim 2, wherein the coating consists of such material that, in the case of the sliding movements between cylinder head gasket and engine component sealing surfaces occurring during operation of the engine, the sliding friction between the gasket sealing surfaces and the engine component sealing surfaces is less than the sliding friction when the basic member would be in direct contact with the engine component sealing surfaces.

15. Cylinder head gasket as defined in claim 1, wherein the cylinder head gasket has on the surface of the elevations provided with the coating a hardness less than the hardness of the coating on its side facing the basic member.

16. Cylinder head gasket as defined in claim 2, wherein the cylinder head gasket has on the surface of the elevations provided with the coating a hardness less than the hardness of the coating on its side facing the basic member.

17. Cylinder head gasket as defined in claim 1, wherein the basic member is deformable in height in the vicinity of at least one screw aperture.

18. Cylinder head gasket as defined in claim 1, wherein the at least one basic member of the gasket sealing surfaces surrounding the combustion chamber apertures is resistant to pressure and creep and is, therefore, not deformable in height around the combustion chamber apertures under the maximum load occurring during the installation of the cylinder head gasket as well as during operation of the engine.

19. Cylinder head gasket as defined in claim 1 with an opening associated with a chain case of the engine and a gasket sealing surface extending in the vicinity of the edge of said opening, wherein the basic member associated with said gasket sealing surface is deformable in height at least in sections.

20. Cylinder head gasket as defined in claim 1, wherein the basic member having the coating has a height profile corresponding to the height profile of the three-dimensional gasket sealing surface borne by said basic member.

21. Cylinder head gasket as defined in claim 2, wherein the basic member having the coating has a height profile corresponding to the height profile of the three-dimensional gasket sealing surface borne by said basic member.

22. Cylinder head gasket as defined in claim 1, wherein the coating has a layer thickness varying in accordance with the height profile of the three-dimensional gasket sealing surface.

23. Cylinder head gasket as defined in claim 2, wherein the coating has a layer thickness varying in accordance with the height profile of the three-dimensional gasket sealing surface.

24. Cylinder head gasket as defined in claim 1, wherein the gasket sealing surfaces are approximately strip-like or line-like.

25. Cylinder head gasket as defined in claim 2, wherein the gasket sealing surfaces are approximately strip-like or line-like.

26. Cylinder head gasket as defined in claim 1, wherein the at least one basic member is deformable in height where irreversible changes in the shape of the engine component sealing surfaces occur during the installation of the cylinder head gasket and/or during operation of the engine.
